(19) United States
(12) Patent Application Publication
(10) Pub. No.: US 2014/0156093 A1
(43) Pub. Date: Jun. 5, 2014

(54) AUTO-DISCOVERY OF SMART METER UPDATE INTERVAL

(71) Applicant: GENERAL ELECTRIC COMPANY, Schenectady, NY (US)

(72) Inventors: Joseph Mark Brian, Louisville, KY (US); Robert Marten Bultman, Louisville, KY (US); Jeff Drake, Louisville, KY (US)

(73) Assignee: GENERAL ELECTRIC COMPANY, Schenectady, NY (US)

(21) Appl. No.: 13/693,088

(22) Filed: Dec. 4, 2012

(51) Int. Cl. G05B 19/02

(52) U.S. Cl. CPC G05B 19/02
USPC 700/291

(57) ABSTRACT

A control device is connected to a smart meter. The control device includes a communication engine configured to retrieve an energy consumption value from a measuring unit coupled to the smart meter based on a polling interval. The control device includes a discovery engine operatively coupled to the communication engine and configured to discover an update interval of the smart meter by increasing the polling interval iteratively from an initial value until a difference is detected between successively retrieved energy consumption values. Furthermore, the device includes a user interface engine, operatively coupled to the discovery engine and the communication engine, configured to estimate a utility consumption at a present time based on the difference value and the polling interval.

### BACKGROUND

The aspects of the disclosed embodiments generally relate to energy management, and more particularly to auto-discovery of a smart meter update interval.

Utility management systems, such as home energy management systems, energy monitors, or energy displays, may receive metering information from a variety of smart meters or other devices that periodically update their cumulative energy, water, or gas consumption at various intervals. For example, an electricity meter might update its consumption value once every thirty seconds, once a minute, or once an hour. This update interval is oftentimes unknown to the person configuring the utility management system.

The update interval or the frequency at which new information arrives must be known to properly display system data at a user interface. Users may be misled if the frequency of updating the user interface differs with the frequency of the update interval of a smart meter. For example, if the update interval of a smart meter is an hour, and the frequency of updating the user interface is a minute, then users will see 59 updates with no change, and then one update with an hour's worth of change. Because a user interface displays data in terms of consumption over time, mismatched update intervals and display intervals will result in a user interface that presents data as though one-hour worth of consumption occurs in one minute which is misleading.

Thus, an energy management system must know the update interval of smart meters in order to adjust polling frequencies. The polling frequencies have a direct impact on the “real-time” nature of the data presented in a system graphical user interface or an in-home display. The faster the polling frequency, the more accurate the visual presentation becomes.

Accordingly, it would be desirable to provide methods and apparatus for auto-discovery of smart meter update interval that addresses at least some of the problems identified above.

### BRIEF DESCRIPTION OF THE DISCLOSED EMBODIMENTS

As described herein, the exemplary embodiments overcome one or more of the above or other disadvantages known in the art.

One aspect of the exemplary embodiments relates to a control device operatively connected to a smart meter. In one embodiment, the control device includes a communication engine configured to retrieve an energy consumption value from a measuring unit coupled to the smart meter based on a polling interval. The control device also includes a discovery engine operatively coupled to the communication engine and configured to discover an update interval of the smart meter by increasing the polling interval iteratively from an initial value until a retrieved energy consumption value exceeds a previously retrieved energy consumption value. Furthermore, the control device includes a user interface engine, operatively coupled to the discovery engine and the communication engine, configured to estimate a utility consumption at a present time based on the difference value between successive retrieved energy consumption values and the polling interval.

Another aspect of the exemplary embodiments relates to a method of discovering the update interval of a smart meter. In one embodiment, the method includes repetitively retrieving an energy consumption value from a measuring unit coupled to the smart meter, the period between successive retrievals, referred to as the polling interval. The update interval is determined by iteratively increasing the initial polling interval until a retrieved value from the measuring unit exceeds a first retrieved energy consumption value. A utility consumption at the present time is estimated based on the value of the difference between successive retrieved values and the polling interval.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

In the drawings:

FIG. 1 is a schematic diagram generally representing an exemplary architecture of system components for a utility management system incorporating aspects of the present disclosure;

FIG. 2 is a demonstrative table showing the relationship between a load and polling interval for a smart meter in an exemplary embodiment incorporating aspects of the present disclosure;

FIG. 3 illustrates a flowchart of a process of discovering the update interval of a smart meter in an exemplary embodiment incorporating aspects of the present disclosure; and

FIG. 4 illustrates a process of determining the average power consumed during a polling interval.

### DETAILED DESCRIPTION OF THE DISCLOSED EMBODIMENTS

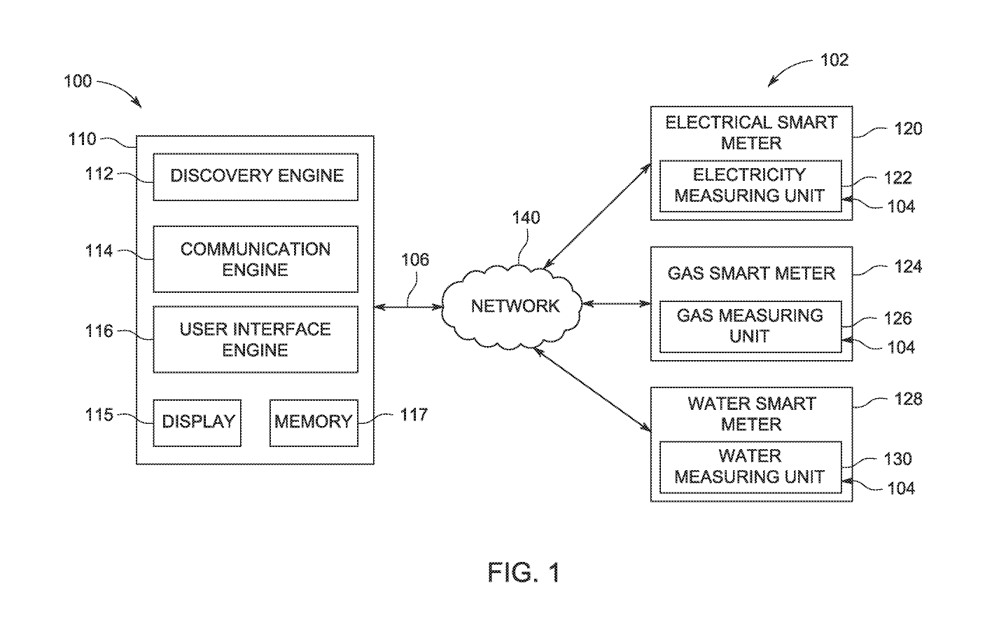

Turning to FIG. 1, there is a schematic diagram generally representing an exemplary architecture of system components for a utility management system 100 incorporating aspects of the present disclosure. The aspects of the disclosure are generally directed towards methods and apparatus for auto-discovery of a smart meter update interval. As will be understood, the various diagrams, flow charts and scenarios described herein are only examples, and there are many other scenarios to which the present disclosure will apply. As illustrated in FIG. 1, in the utility management system 100, a control device 110 is communicative coupled to one or more smart meters 102. In the embodiment shown in FIG. 1, the control device 110 can be coupled to the smart meter(s) 102 via the network 140. Alternatively, the control device 110 can be coupled to the smart meter(s) 102 via a wired connection.

In one embodiment, the control device 110 is configured as an energy monitor, also known as electricity monitor and electricity usage monitor. For example, an energy monitor, as is generally understood, can be used to provide users real-time energy usage information, including the cost or carbon emissions associated with the energy. The environment of energy usage can be any suitable environment, such as a home or commercial establishment. Advanced features may be derived from the real-time energy usage information, such as setting alarms for reaching a threshold of energy consumption. In general, energy monitors are used to track energy usage of, for example a home, and provide information to users for conserving energy consumption in the home.

In one embodiment, the control device 110 is configured to function as a home energy gateway (“HEG”) which provides energy management and control features beyond monitoring and reporting. For example, a home energy gateway may construct detailed profiles of energy consumption based on time or even individual appliance use through continuous monitoring of energy consumption. Moreover, a home energy gateway may provide users the ability to either remotely control home devices or automate them with optimized energy consumption profiles. Therefore, a home energy gateway makes it possible to achieve a better time or geographical distribution of energy consumption, reduce the overall energy usage and save energy cost for consumers.

The term “smart meter” as is used herein, generally refers to metering devices that are used to monitor and measure the consumption of a utility resource, such as one or more of electricity, natural gas or water. In one embodiment, the smart meter(s) 102 of the system 100 shown in FIG. 1 can include one or more of an electricity smart meter 120, a gas smart meter 124, and a water smart meter 128. Each smart meter 102 includes or is operably connected to at least one measuring unit 104. The measuring unit(s) 104 is configured to detect a specific energy consumption property related to, or being monitored by the smart meter 102. In the embodiment of FIG. 1, the electricity smart meter 120 includes an electricity measuring unit 122. The gas smart meter 124 includes a gas measuring unit 126, and the water smart meter 128 includes a water measuring unit 130. In one embodiment, measuring units 122, 126, 130 may record information and data pertaining to the consumption of electric energy, natural gas, or water. This information can be measured, collected and communicated back to, for example, the utility for monitoring and billing purposes or the consumer for energy monitoring and conservation purposes. In the embodiments described herein, electric energy may be measured by the electricity measuring unit 122 in units of cumulative watt-hour. Natural gas consumption can be measured by the gas measuring unit 126 in units of volume, such as cubic feet, while water consumption can be similarly measured by the water measuring unit 130 in units of cubic feet. In alternate embodiments, the measuring units can be any suitable measuring units. As a part of an advanced metering infrastructure (AMI), smart meters 102 may enable two-way communication between the meter 102 and a central utility system (not shown). The smart meter(s) 102 can also be configured to communicate with the control device 110.

In the embodiment of FIG. 1, the network 140 may be a wired local area network (LAN) or a wireless LAN (WLAN). In alternate embodiments, the network 140 can be any suitable communication network that enables the communication of data and information between the control device 110 and the smart meter(s) 102.

The network 140 may also be configured to utilize communication protocols particularly suitable for low power consumption, low data rate, and short-distance communications, such as Bluetooth or ZigBee. ZigBee is a high level communication protocol using small, low-power digital radios based on an IEEE 802 standard for personal area networks (PANs) or home area networks (HANs). In alternate embodiments, any suitable communication protocol can be used.

In one embodiment, the control device 110 may include a discovery engine 112, a communication engine 114, and a user interface engine 116. The communication engine 114 is configured to obtain data from the measuring unit 104 at the smart meter 102 based on a polling interval. The communications engine 114 may be configured to communicate over one or more communication channels 106 in one or more communication protocols, such as for example RS-232 serial communication, RS-485 serial communication, IEEE 802.11 wireless, IEEE 802.15 wireless, Zigbee wireless, Bluetooth wireless, USB, IEEE 802.3x, IEEE-1394, IEEE 802.15.4, IrDA or other suitable communications protocol. In one embodiment, the communication channel(s) 106 may also be encrypted.

The communication engine 114 generally communicates with various smart meters 102 in a two-way communication models. In a two-way communication model, the communication engine 114 may use a radio transceiver to send a signal to a particular smart meter 102 and request the smart meter 102 to wake up from a resting state and transmit its data. Subsequently, the communication engine 114 receives the requested data from the smart meter 102. The interval between two adjacent data polling points is referred to herein as the polling interval. The polling interval is determined by the discovery engine 112.

The discovery engine 112, operatively coupled to the communication engine 114, is configured to discover the update interval of a smart meter 102 and determine the polling interval accordingly. In one embodiment, the discovery engine 112 increases the polling interval iteratively from an initial or default value until the measurement value retrieved from the measuring unit 104 changes.

The user interface engine 116 is generally configured to enable communication between the control device 110 and a user, such as a consumer or utility. In one embodiment, the user interface engine 116 includes a display 115. The display 115 can allow a user to review data and information, as well as control the programming and functions of the control device 110, as well as the smart meter 102, in some embodiments. In one embodiment, the display 115 is or includes a control panel or touch screen display, such as that seen on the wall of a home or a panel of appliance, for example.

The smart meter 102 is configured to identify a property of what is being measured. In one embodiment, the property generally comprises two parts: a number and its unit of measurement. Anything below the minimum unit of measurement of a smart meter 102 generally cannot be measured by the smart meter 102. Therefore, the polling interval must be long enough to allow a measurable difference to be detected by the smart meter 102. Utility consumption causes the readings of a smart meter 102 to change. Therefore, the minimum polling interval is related to the minimum system load or consumption. In general, as the polling interval increases, the required minimum system load decreases.

In one embodiment, the user interface engine 116, operatively coupled to the discovery engine 112 and the communication engine 114, is configured to present information to users about the utility consumption based on the difference between successive retrieved measurement values and the polling interval. The aspects of the disclosed embodiments generally calculate an average historical power value based on some elapsed time, e.g., the polling interval.

Those skilled in the art will appreciate that the functions implemented within the blocks illustrated in the diagram may be implemented as separate components or the functions of several or all of the blocks may be implemented within a single component. For example, the discovery engine 112 may be implemented together with the communication engine 114. As another example, the functions of the user interface engine 116 may be incorporated into the discovery engine 112.

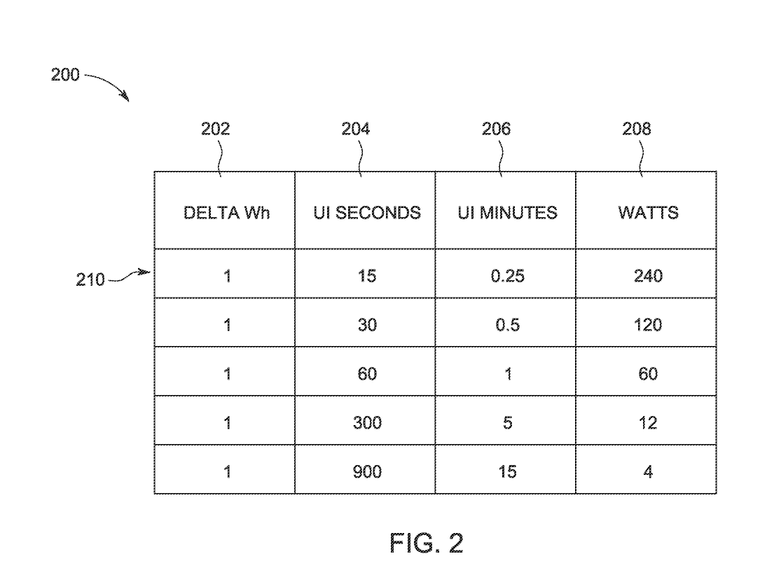

Referring to FIG. 2, table 200 illustrates an exemplary relationship between the load and the update interval for a smart meter 102 in one embodiment of the present disclosure. In the embodiments disclosed herein, the update interval is a pre-set or fixed function of the smart meter 102, and is a fixed or preset time interval, typically set by the manufacturer, and is not a function of system load. In the embodiment illustrated in FIG. 2, the electricity smart meter 102 utilizes a cumulative watt-hour (“Wh”) unit of measurement. The first column 202, labeled as Delta Wh, indicates that one watt-hour is used in the illustrative embodiment as the minimum measurable difference between two polling events of the control device 110. The minimum measurable difference for a particular meter is set by the manufacturer. One watt-hour is a typical value used by manufacturers for such meters. In alternate embodiments, any suitable unit of measure can be used, such as for example 10 watt-hours or 1000 watt-hours. The second column 204, labeled as UI Seconds provides the update interval in terms of seconds, while the third column 206, labeled as UI Minutes, provides the update interval in terms of minutes. The fourth column 208, labeled as Watts, illustrates the minimum measurable load for the corresponding update interval. As is illustrated in FIG. 2, as the update interval, represented by columns 204, 206, increases, the minimum measurable load decreases. Generally, there must be a sufficient load on the system or property being monitored by the smart meter 102 so that the smart meter 102 will detect at least the minimum measurable difference, in this embodiment, 1 Wh of consumption, within its fixed update interval. For example, referring to row 210 of Table 200, for the update interval of 15 seconds, the minimum measurable load required so that the smart meter 102 will detect 1 Wh of consumption is 240 watts, as is shown in column 204.

The aspects of the disclosed embodiments control the polling interval based on the detected or discovered update interval. As the update interval of the smart meter 102 is typically pre-set by the manufacturer, the system load does not affect the update interval of the smart meter 102. Rather, the system load only affects the ability to properly discover the correct polling interval to be used by the communication engine 114 to poll the smart meter 102. The minimum load is fixed as a function of the update interval of the meter. In one embodiment, the discovery engine 112 is configured to detect or determine if a minimum measureable load is connected with a smart meter 102. If no minimum measurable load is detected, for a given update interval, the discovery engine 112 can so inform the user, through for example, the user interface engine 116 either directly via the display 115, and also inform the user that a load greater than a pre-determined level is required. For example, referring to the table in FIG. 2, when the update interval is 15 seconds, a pre-determined measurable load of greater than or equal to approximately 240 watts is required. If this condition is met, the update interval for any meter with an update interval of 15 seconds or longer can be discovered by discovery engine 112 of control device 110, and the appropriate polling interval to be used by the communication engine 114 for polling that meter can be determined.

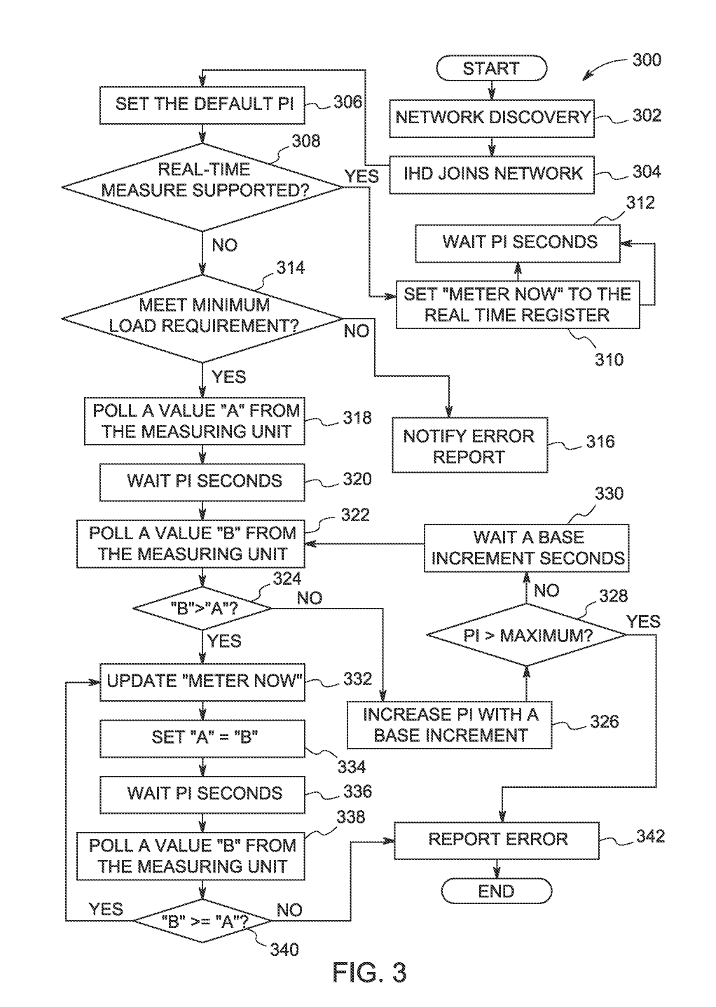

Referring to FIG. 3, a flowchart of a process 300 of discovering the update interval of a smart meter 102 in an exemplary embodiment incorporating aspects of the present disclosure is illustrated.

In one embodiment, the control device 110 is configured to discover 302 the network 140. For example, in the case where network 140 comprises a ZigBee™ network, the control device 110 can use the active scan service of its Media Access Control (MAC) to broadcast a beacon request. As is understood, other devices in the range may respond with an 802.15.4 beacon frame which contains MAC information about the responding device as well as a beacon payload. The beacon payload will generally contain ZigBee network information such as the protocol information, allowed routers and end devices.

With the discovered network information, the control device 110 determines 304 whether to join the network 140. For example, in the case of a ZigBee network, the control device 110 may call the MAC's association service to send a join request to the potential parent node in the ZigBee network. If the join was successful, the control device 110 will obtain its new network address, personal area network (PAN) ID, the neighbor table, and other networking information. Afterwards, the control device 110 will make an announcement and inform other devices in the same ZigBee network of its 16-bit network address as well as its 64-bit IEEE address.

In one embodiment, the control device 110 sets 306 the initial or default polling interval, referred to in the figures as “PI”. In this embodiment, the control device 110 sets 306 the initial or default polling interval (PI) to be 15 seconds, the shortest update interval likely to be implemented in smart meters currently likely to be encountered in the field. This requires that the minimum measurable load be at least approximately 240 watts, as is shown in FIG. 2. In alternate embodiments, any suitable time interval other than including 15 seconds can be used as the default polling interval. In accordance with the aspects of the disclosed embodiments, the default polling interval should substantially match the fastest update interval that could be observed during actual use. In practice, the selected default polling interval value must be shorter than or equal to the actual update interval used by the smart meter 102. As noted, the update interval is a fixed attribute of the smart meter 102 and it does not change. However, there is a variety of smart meters in the marketplace, and control device 110 must adapt to the characteristics of the smart meter(s) in its network. The present disclosure enables the control device 110 to discover the update interval for its' associated smart meter. The polling interval can be controlled and the default polling interval or seed value must be shorter than or equal to the actual update interval used by the meter. The minimum load is dependent on the default polling interval is selected or specified. As noted in the table of FIG. 2, for a default interval of 15 seconds, 240 W is required. For a default interval of 30 seconds, 120 W minimum load is required. The minimum load is also a function of the meter resolution. For 1 watt-hour is 240 watts and a 15 second update interval. For 10 watt-hours it is 240 watts and a 15 second update interval. As is described in further detail below, the aspects of the disclosed embodiments select as the initial or default polling interval, one that matches the fastest known polling interval. If a match is not found, the value of polling interval is lengthened iteratively, until the update interval of the smart meter 102 is discovered.

The control device 110 will determine 308 whether the smart meter 102 supports real-time data measurement. If the smart meter 102 does support real-time measurement, there is no need of discovering the update interval. In such a configuration, the smart meter 102 can be configured to directly provide the desired meter readings without needing to poll values over time and calculate measurements. For example, in one embodiment, if the smart meter 102 supports real-time measurement, the control device 110 can be configured to set 310 the “meter now” reading to the real time register in the smart meter 102. The term “meter now” as used herein generally indicates the average power value that is presented on the display 115 at the present time. This allows the user to determine the current power utilized at a current instant of time. In one embodiment, the meter 102 directly provides the “meter now” reading, if real time power reporting is supported. Where real time power reporting is not supported, the “meter now” value can be calculated using the polling interval algorithm described herein.

In one embodiment, after waiting 312 the polling interval (in seconds), the control device 110 can again update the “meter now” reading with current value of the real time register in the smart meter 102. In one embodiment, this reading is provided from the smart meter 102 in terms of instantaneous kW each time it is requested from the smart meter 102. The polling interval determines how often a reading is requested from the smart meter 102. Since the smart meter 102 is directly providing the current power being utilized, the smart meter 102 is interrogated for the “meter now” reading, and the reading is presented on the display 115. After the wait 312, the process can be repeated.

If the smart meter 102 does not support real-time measurement, the control device 110 can determine 314 if the minimum load requirement is met. For example, if the discovery engine cannot detect a minimum load at its default (initial) polling frequency, a prompt can be provided to ensure that there is sufficient load on the system. In one embodiment, the prompt can be provided to the user via the user interface engine 116 and display 115. With reference to FIG. 2, any load greater than 240 W will work for meter update intervals of 15 seconds or longer. If it is determined 314 that the minimum load requirement is not met, the user can be notified by an error message presented 316 on the user interface 116 of the minimum required load.

If the minimum load is active, meaning the minimum load requirement is met, then an energy consumption value A is polled or retrieved 318 from the measuring unit 104. The energy consumption value “A” is generally the first value measured by or stored in the measuring unit 104 of the smart meter 102 if either the system load is met or has been increased to meet the minimum load requirement. After waiting 320 a period of time corresponding to the polling interval PI, an energy consumption value B is polled or retrieved from the measuring unit 104.

If it is determined 324 that the value B is not greater than the value A, this indicates that there is no change in the measurement by the measuring unit 104 coupled to the smart meter 102 (i.e., the measurement value has not increased). This generally indicates that the polling interval is too short, i.e., the smart meter 102 is being polled too fast, and the polling interval must be lengthened. In one embodiment, the polling interval PI is increased 326 by a default or base increment value. Generally, the base increment value is less than the value of the polling interval. For example, if the polling interval is 15 seconds, a base increment value of 5 seconds may be used.

If it is determined 328 that the current polling interval is greater than a maximum allowed polling interval, an error is reported 342. Otherwise, thereafter a wait 330 corresponding to the current polling value and base increment value, a measurement value B is again polled 322 from the measuring unit 104.

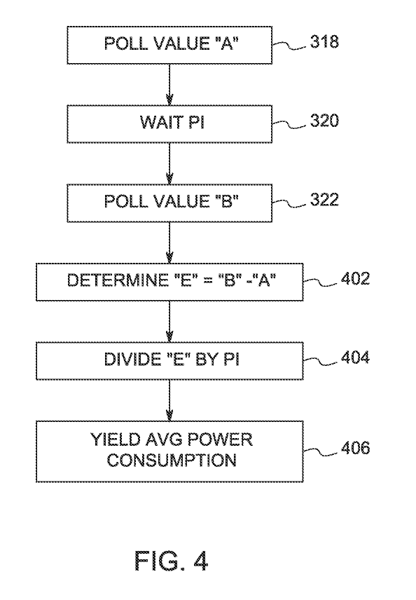

A determination 324 that the measurement value B is greater than the measurement value A generally indicates that there is a change at the measuring unit 104 during the update interval. This measurement value B, indicative of a change at the measuring unit 104, is used to determine the average power consumed during the interval. Referring to FIG. 4, in one embodiment, a calculation is performed that takes 402 the difference of B and A (representing the consumed watt hours during the polling interval), and divides 404 that number by the elapsed time (the polling interval), which yields 406 a number representing the average power consumed during the interval. For example, if 1 watt-hour is consumed in 15 seconds, that is equivalent to 240 W average. (1 Wh/[(15 sec)/(3600 sec/hr)]=240 Watts.

Referring again to FIG. 3, the current polling interval is reset to be the sum of the current polling value plus the base increment value represents the approximate update interval for the smart meter and is used as the polling interval moving forward. In this embodiment, the updating 332 is effectuated by setting 334 the measurement value A equal to the measurement value B, waiting 336 a period of time corresponding to the current polling interval, and then polling 338 the measurement value B from the measurement unit 104.

The measurement value B should not be less than the previous measurement value A, because in a consumption system, the cumulative utility consumption must increase over time. If it is determined 340 that the measured value B is not greater than or equal to the measured value A, an error is reported 342. Otherwise, the average power value is updated and propagated to the user interface 116 as described above. By this method, when operating in the updating loop 332, 334, 336, 338 and 340) a utility consumption, in this embodiment, the average power, is estimated based on the values of successive retrieved consumption values and the polling interval, and in one embodiment more particularly by dividing the difference between successive values by the duration of the polling interval.

The aspects of the disclosed embodiments are directed to automatically discovering the update interval of a smart meter. Initial baseline assumptions pertaining to an estimated update interval being used by a meter are made. The baseline assumptions are then tested over time to learn the update interval that is being used by the meter.

Thus, while there have been shown, described and pointed out, fundamental novel features of the invention as applied to the exemplary embodiments thereof, it will be understood that various omissions and substitutions and changes in the form and details of devices and methods illustrated, and in their operation, may be made by those skilled in the art without departing from the spirit or scope of the invention. Moreover, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An control device operatively connected to a smart meter, comprising:
a communication engine configured to periodically retrieve an energy consumption value measurement from a measuring unit coupled to the smart meter based on a polling interval;
a discovery engine, operatively coupled to the communication engine, configured to discover an update interval of the smart meter by increasing the polling interval iteratively from an initial value until a subsequently retrieved energy consumption value exceeds a value of a first retrieved energy consumption value; and
a user interface engine, operatively coupled to the discovery engine and the communication engine, configured to estimate a utility consumption at a present time based on the values of successively retrieved energy consumption values and the polling interval.

2. The control device of claim 1, wherein the discovery engine is further configured to increase the polling interval linearly with a base increment.

3. The control device of claim 1, wherein the user interface engine is further configured to estimate the utility consumption based on the successively retrieved energy consumption values of the measuring unit.

4. The control device of claim 1, wherein the smart meter comprises an electricity meter.

5. The control device of claim 6, wherein the measuring unit is a cumulative watt-hour register.

6. The control device of claim 1, wherein the smart meter comprises a gas or water meter.

7. The control device of claim 8, wherein the measuring unit comprises a cumulative volume register.

8. A method of discovering an update interval of a smart meter, comprising:
determining an initial polling interval;
retrieving an energy consumption measurement value from a measuring unit coupled to the smart meter based on the initial polling interval;
determining the update interval by increasing the initial polling interval iteratively until a subsequently retrieved energy consumption measurement value exceeds a first retrieved energy consumption measurement value; and
estimating a utility consumption at a present time based on the difference between successively retrieved measurement values and the polling interval.

9. The method of claim 8, further comprising updating an in home display with the utility consumption at the present time.

10. The method of claim 8, wherein increasing the initial polling interval iteratively further comprises increasing the initial polling interval linearly with a base increment.

11. The method of claim 8, wherein the smart meter comprises an electricity meter.

12. The method of claim 11, wherein the measuring unit comprises a cumulative watt-hour register.

13. The method of claim 8, wherein the smart meter comprises one or more of a gas or water meter.

14. The method of claim 13, wherein the measuring unit is a cumulative volume register.
